(19) United States
(12) Patent Application Publication
(10) Pub. No.: US 2008/0134574 A1
(43) Pub. Date: Jun. 12, 2008

(54) TREE AND SHRUB APRON

(76) Inventor: Mickey Zimmer, Adamstown, MD (US)

Correspondence Address: CARLSON, GASKEY & OLDS, P.C., 400 WEST MAPLE ROAD, SUITE 350, BIRMINGHAM, MI, 48009, US

(21) Appl. No.: 11/609,554

(22) Filed: Dec. 12, 2006

(51) Int. Cl. A01G 13/02

(52) U.S. Cl. 47/31

(57) ABSTRACT

A tree and shrub apron h is placed around a plant and mulch is used to retain the apron in place. The apron is sized and shaped to correspond to the type plant. A time released fertilizer is adhered to the apron. The type of fertilizer would be predetermined by the intended plant application of the apron. Other substances may also be contained in the fertilizing and adhesive mixture, such as, pesticides. The release of the fertilizer would be activated by moisture applied to the apron. The apron will begin to biodegrade once placed on the ground and the fertilizer is activated.

### BACKGROUND OF THE INVENTION

The present invention relates generally to a biodegradable tree and shrub apron which contains fertilizer.

Tree and shrub aprons are placed about the trunks of plants to protect the plant from environmental hazards, such as frost, and to prevent root damage. The apron is typically placed around the plant for one season. At the end of the season the apron must often be disposed of or stored until is again needed. To eliminate the problem of storing and disposing of aprons biodegradable aprons are sometimes used. Unfortunately, every time the plant is to be fertilized or watered the apron must be removed. This can be difficult and time consuming depending on how the apron is secured around the plant and whether mulch has been used which much be removed prior to the apron.

Prior aprons containing fertilizers are not also biodegradable, or are complex multi-layer products that may prevent water migration or provide complex features which are not required by the average gardener.

Accordingly, an arrangement to provide a simplified apron which is biodegradable and contains fertilizer is desired.

### SUMMARY OF THE INVENTION

In the disclosed embodiment of this invention, a tree and shrub apron is biodegradable and contains fertilizer.

A tree and shrub apron having generally circular shape is placed around a plant. The apron defines a hole that is sized and shapes to correspond to the desired plant. A slit extending from an outer edge of the apron to the hole allows the apron to be placed around the plant with minimum difficulty. Mulch can be placed over the apron to retain the apron in place.

A time released fertilizer is adhered to the apron material. The type of fertilizer would be predetermined by the intended plant application of the apron. Other substances may also be contained in the fertilizing and adhesive mixture, such as, pesticides. The release of the fertilizer would be activated by moisture applied to the apron by rain or by moisture in the soil or mulch placed over the apron. The time release can be designed to last over a season, or longer depending on the intended climate and plant.

The apron will begin to biodegrade once placed on the ground and the fertilizer is activated. The rate of degradation of the apron would allow the apron to last to the end of a season.

The apron increases the water and fertilizer intake of a plant and enhances the growth and development of the plant and the roots. The apron also protects the plant and the roots from environmental hazards, such as water stress, root disease, and transplant shock to the plant

These and other features of the present invention can be best understood from the following specification and drawings, the following of which is a brief description.

### BRIEF DESCRIPTION OF THE DRAWINGS

FIG. 1 is a perspective view of an example apron placed around a plant.

FIG. 2 is a top view of the example apron.

FIG. 3 shows an enlarged view of a section of the apron.

### DETAILED DESCRIPTION OF THE PREFERRED EMBODIMENT

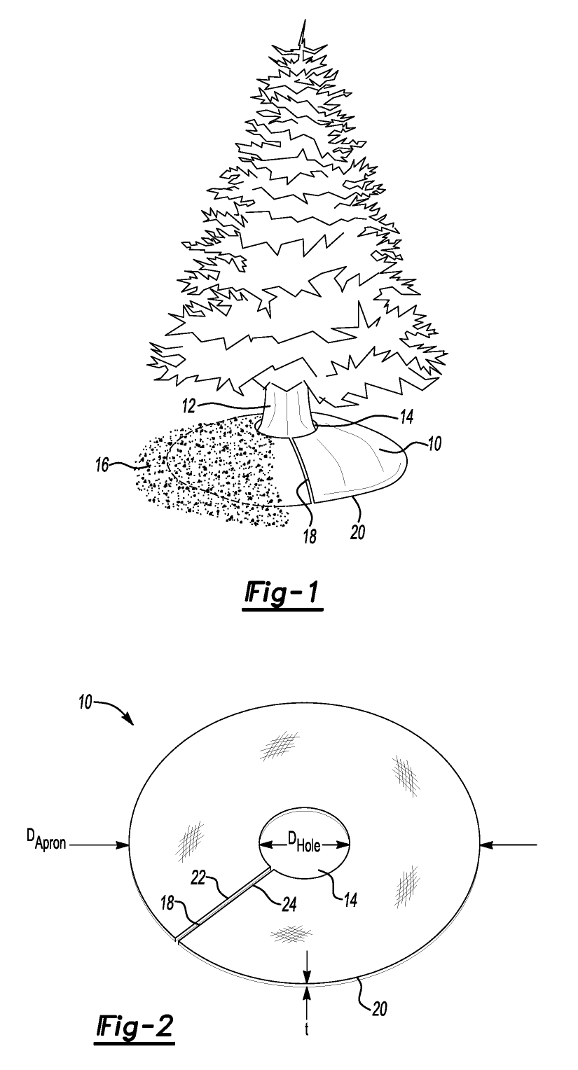

FIG. 1 shows tree and shrub apron 10 placed around a plant 12. The apron 10 preferably has a generally circular shape and defines a hole 14 located at approximately the center of the apron 10. The hole 14 is typically circular in shape to correspond to the plant 12.

Mulch 16 can be placed over the apron 10 to retain the apron 10 in place around the plant 12. In addition to providing additional moisture and fertilization to the plant 12, the mulch 16 would aid in degradation the apron 10 as well.

FIG. 2 illustrates a top view of the example apron 10. A slit 18 extends from an outer edge 20 of the apron 10 to the hole 14. The slit 18 allows the apron 10 to be placed around the plant 12, as shown in FIG. 1, with minimum difficulty. The apron 10 may be placed such that a first end 22 located on one side of the split and a second end 24 located on the other side of the split overlap. The apron 10 has a diameter Dₐₚᵣₒₙ and the hole 14 has a diameter Dₕₒₗₑ. The apron diameter Dₐₚᵣₒₙ and the hole diameter Dₕₒₗₑ are determined by the size of the desired plant 12 for the apron 10 to be placed around. The thickness t of the apron 10 may be varied to provide the plant greater environmental protection, longer life, or increased moisture flow to the soil. The thickness t may changed by utilizing thicker material or by different manufacturing techniques, such as weaving the material looser or tighter. Typical thickness can vary from ¼ to ⅝ inches.

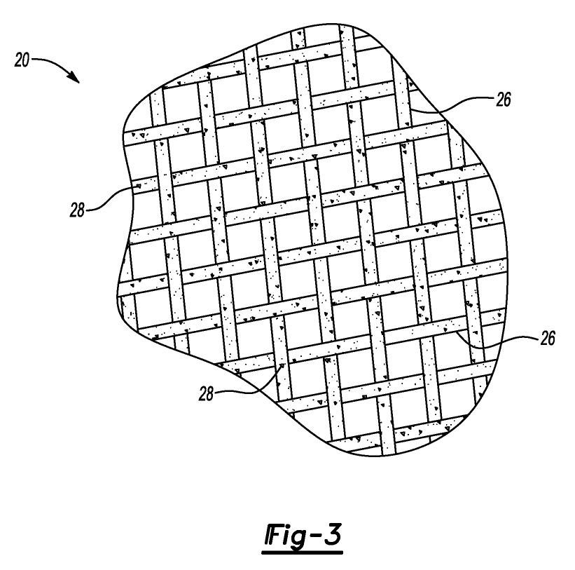

FIG. 3 is an enlarged view of a portion of the apron 10. The apron 10 is preferably woven from threads 26 of burlap, or a similar material. Fertilizer 28 is adhered to the threads 26. The fertilizer 28 may be adhered by placing the threads 26 within a substance containing a fertilizing material and an adhesive mixture. The adhesive would retain the fertilizer to the threads 26. The threads 26 may be soaked in the fertilizing and adhesive mixture either prior to or following being woven together. Alternately the fertilizer 28 may be placed within the threads 26 of the material when they are created.

The type of fertilizer 28 adhered to the apron 10 would be predetermined by the intended application for the apron 10. For example, the fertilizer 28 may be specifically chosen for use with coniferous or deciduous trees or for use with shrubs. Other substances may also be contained in the fertilizing and adhesive mixture, such as, pesticides.

The fertilizer 28 is preferably a time released fertilizer. The release of the fertilizer 28 would be activated by moisture. The water can be applied to the apron 10 to activate the fertilizer 28 either by a person or by rain. Alternatively, moisture in the soil, or mulch placed over the apron 10, can activate the fertilizer 28. The time release of the fertilizer 28 can be designed to last over a season, or longer depending on the intended climate and plant 12 the apron 10 is intended for.

Similarly the apron 10 will begin to biodegrade once placed on the ground and the fertilizer 28 is activated. The rate of degradation of the apron 10 would allow the apron 10 to last at least as long as the fertilizer 28 and may correspond to the time release of the fertilizer 28. Preferably, at the end of a season the fertilizer 28 has been released and the apron 10 has completely degraded. A new apron 10 may be applied for the next season.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A tree and shrub apron comprising:
a material woven into a mat having a hole defined in the center of the mat and a slit extending from an outer edge to the hole, wherein the material is biodegradable and a fertilizer is adhered to a surface of the material.

2. The apron of claim 1, wherein the fertilizer is a time released fertilizer and the fertilizer is released over a predetermined time frame.

3. The apron of claim 2, wherein the fertilizer is released by moisture.

4. The apron of claim 2, wherein the time frame is determined based upon a desired plant.

5. The apron of claim 2, wherein the time frame is determined based upon a climate season.

6. The apron of claim 2, wherein the material is biodegrades after the fertilizer has been released.

7. The apron of claim 6, wherein the life of the material is equal to the time frame for fertilizer release.

8. The apron of claim 1, wherein the size of the material, and the hole defined by the material are determined by a desired plant.

9. The apron of claim 1, wherein the material is placed under mulch for a plant.

10. The apron of claim 1, wherein a pesticide is adhered to the surface of the material.

11. A tree and shrub apron comprising:
a mat having a hole defined in the center of the mat and a slit extending from an outer edge to the hole to allow placing the mat around a plant trunk, wherein the mat is a biodegradable and a time released fertilizer is contained within the mat.

12. The apron of claim 11, wherein the fertilizer is released over a predetermined time frame based upon the desired plant.

13. The apron of claim 11, wherein the fertilizer is released by moisture.

14. The apron of claim 11, wherein the type of fertilizer is determined by the desired plant.

15. The apron of claim 11, wherein the time release of the fertilizer is determined based upon a climate season.

16. The apron of claim 11, wherein the material is biodegrades after the fertilizer has been released and the life of the material is equal to the time frame for fertilizer release.

17. The apron of claim 11, wherein the fertilizer is contained within threads that are woven to form the mat.

18. The apron of claim 11, wherein the size of the mat, and the hole are determined by the desired plant.

19. The apron of claim 11, wherein the material is placed under mulch for the plant.

20. The apron of claim 11, wherein a pesticide is contained within mat.
